(19) United States
(12) Patent Application Publication
(10) Pub. No.: US 2017/0364077 A1
(43) Pub. Date: Dec. 21, 2017

(54) UNMANNED AERIAL VEHICLE, MOTOR CONTROL DEVICE AND METHOD

(71) Applicant: ZEROTECH (SHENZHEN) INTELLIGENCE ROBOT CO., LTD., Shenzhen (CN)

(72) Inventors: Yu Sun, Haidian District (CN); Xianlong Zhan, Haidian District (CN); Xiao Zhu, Haidian District (CN)

(73) Assignee: ZEROTECH (SHENZHEN) INTELLIGENCE ROBOT CO., LTD., Shenzhen (CN)

(21) Appl. No.: 15/348,565

(22) Filed: Nov. 10, 2016

(30) Foreign Application Priority Data
Jun. 15, 2016 (CN) 201610424304.X

(51) Int. Cl. G05D 1/00; B64C 39/02; H02P 5/56

(52) U.S. Cl. CPC G05D 1/0094; H02P 5/56; B64C 39/024

(57) ABSTRACT

The disclosure relates to an unmanned aerial vehicle, a motor control device and method for controlling the same. The motor control method includes: acquiring current attitude information of a load, target attitude information of the load and current operation parameter information of one or more motors on the load, and obtaining control information for controlling the one or more motors in accordance with the acquired information above; transmitting the control information to a shared memory for storage; reading the control information from the shared memory, and controlling operation of the one or more motors in accordance with the control information. In one embodiment, the motor control device does not require cable or PCB wiring to connect a main control unit and an execution unit, reducing the size of hardware. Moreover, with the shared memory, the speed and stability of data interaction between the main control unit and the execution unit may be improved.

### CROSS-REFERENCE TO RELATED APPLICATION

The present application claims the priority to a Chinese patent application No. CN201610424304.X, filed with the State Intellectual Property Office on Jun. 15, 2016 and entitled “Unmanned Aerial vehicle, Motor Control Device and Method”, the content of which is hereby incorporated by reference in its entirety.

### TECHNICAL FIELD

The present disclosure relates to the field of flight control techniques for an unmanned aerial vehicle (UAV), and particularly to a UAV, a motor control device and method.

### BACKGROUND

A gimbal may be coupled to a UAV, so as to carry a camera, a lighting lamp and the like. The gimbal is generally provided with three motors on a pitching axis, a rolling axis and a yaw axis, respectively. A high speed attitude of the gimbal is achieved by the three motors in such a manner that the three motors perform a locating operation precisely in accordance with a signal received from a controller. The controller generally includes a main control unit and three execution units respectively controlling rotations of the three motors. The main control unit is configured to process sensor data and achieves functions, such as stability augmentation and following up of the gimbal, during the flight of the UAV. The execution units are configured to control the three motors to rotate in accordance with related data from the main control unit.

Conventionally, each of the three execution units requires one processor, and the main control unit also requires one processor, that is to say, a total of four processors are required. In this case, a large space is occupied by a control circuit for the motors, PCB (Printed Circuit Board) wiring is complicated, and the system is likely to be unstable due to cables between the processors. Furthermore, there may be a low efficiency of communication between the main control unit and the execution unit due to a processing delay of the execution unit.

### DISCLOSURE OF THE INVENTION

In view of this, one object of the present disclosure is to provide a UAV, a motor control device and method, so as to solve technical problems of a large space occupied by the control circuit for the motors, complicated PCB wiring, poor stability of system, and low efficiency of communication between the main control unit and the execution unit.

In order to achieve the above object, embodiments of the present disclosure employ technical solutions as follows.

In one aspect, a motor control device is provided by an embodiment of the present disclosure, which is configured to control one or more motors on a load. The motor control device includes an execution unit, a main control unit and a shared memory. The main control unit is configured to acquire current attitude information of the load, target attitude information of the load and current operation parameter information of the one or more motors on the load, obtain control information for controlling the one or more motors in accordance with the current attitude information, the target attitude information and the current operation parameter information, and transmit the control information to the shared memory for storage. The execution unit is configured to read the control information from the shared memory, and control operation of the one or more motors in accordance with the control information.

In another aspect, a motor control method is further provided by an embodiment of the present disclosure, for controlling one or more motors on a load. The motor control method includes: acquiring current attitude information of the load, target attitude information of the load and current operation parameter information of the one or more motors on the load, and obtaining control information for controlling the one or more motors in accordance with the current attitude information, the target attitude information and the current operation parameter information; transmitting the control information to a shared memory for storage; and reading the control information from the shared memory, and controlling operation of the one or more motors in accordance with the control information.

In another aspect, a UAV is further provided by an embodiment of the present disclosure. The UAV includes a load having one or more motors, a memory, one or more processors and one or more modules. The one or more modules are stored in the memory and executed by the one or more processors. The one or more modules include an execution module, a main control module and a data storage module. The main control module is configured to acquire current attitude information of the load, target attitude information of the load and current operation parameter information of the one or more motors on the load, obtain control information for controlling the one or more motors in accordance with the current attitude information, the target attitude information and the current operation parameter information, and transmit the control information to the data storage module for storage. The execution module is configured to read the control information from the data storage module, and control operation of the one or more motors in accordance with the control information.

In another aspect, a computer readable medium is further provided by an embodiment of the present disclosure, which has nonvolatile program codes executable by a processor. The program codes, when executed by the processor, execute the following method to control one or more motors on a load: acquiring current attitude information of the load, target attitude information of the load and current operation parameter information of the one or more motors on the load, and obtaining control information for controlling the one or more motors in accordance with the current attitude information, the target attitude information and the current operation parameter information; transmitting the control information to the shared memory for storage; and reading the control information from the shared memory, and controlling operation of the one or more motors in accordance with the control information.

With the UAV, the motor control device and method provided by the embodiments of the present disclosure, the current attitude information of the load, the target attitude information of the load and the current operation parameter information of the one or more motors on the load are acquired, and control information for controlling the one or more motors is obtained in accordance with the current attitude information, the target attitude information and the current operation parameter information; the control information is transmitted to the shared memory for storage; and the control information is read from the shared memory, and the operation of the one or more motors is controlled in accordance with the control information. In the UAV, the motor control device and method provided by the embodiments of the present disclosure, since the shared storage unit is used as a data interactive medium, the control circuit for the motors no longer needs any cable or PCB wiring to connect the main control unit and the execution unit, thereby reducing the size of hardware. Moreover, such a data interactive medium enables information transmission to be implemented directly inside a chip, thereby improving the reliability of communication, preventing a hidden trouble that one or some motors do not respond due to disconnection of a communication line, and further improving the speed and stability of data interaction between the main control unit and the execution unit.

In order to make the above objects, features and advantages of the present disclosure easy to be understood, particular embodiments will be illustrated in detail hereinafter, in conjunction with the drawings.

### BRIEF DESCRIPTION OF DRAWINGS

In order to more clearly illustrate technical solutions of the embodiments in the present disclosure, drawings of the embodiments will be briefly introduced hereinafter. It should be understood that, drawings below merely show some embodiments of the present disclosure and thus shall not be considered to limit the scope of the present disclosure Other related drawings can also be obtained, in light of these drawings, by those skilled in the art without departing from the scope and spirit of the disclosure.

FIG. 1 shows a structural block diagram of a motor control device provided by an embodiment of the present disclosure;

FIG. 2 shows a structural block diagram of a motor control device provided by another embodiment of the present disclosure;

FIG. 3 shows a structural block diagram of a motor control device provided by still another embodiment of the present disclosure;

FIG. 4 shows a structural block diagram of a motor control system in which the motor control device provided by an embodiment of the present disclosure is applied;

FIG. 5 shows a flowchart block diagram illustrating a motor is controlled by an execution unit provided by an embodiment of the present disclosure;

FIG. 6 shows a flowchart of a motor control method provided by an embodiment of the present disclosure; and

FIG. 7 shows a structural block diagram of various modules included in an UAV provided by an embodiment of the present disclosure.

### DETAILED DESCRIPTION OF EMBODIMENTS

The technical solutions in the embodiments of the present disclosure will be described clearly and completely hereinafter, in conjunction with drawings used for the embodiments of the present disclosure. More obvious variations and modifications will become apparent to those of ordinary skill in the art without departing from the scope of this disclosure. Generally, components in the embodiments of the present disclosure, which are described and illustrated in these drawings herein, can be arranged and designed in different configurations. Therefore, the following detailed description of the embodiments of the present disclosure provided in the drawings is not intended to limit the scope of protection of the present disclosure, but merely present the selected embodiments of the present disclosure. All of the other embodiments, obtained by those skilled in the art in accordance with the embodiments of the present disclosure without paying any creative effort, fall within the scope of protection of the present disclosure.

It should be noted that similar reference signs and letters represent similar items in the following drawings. Therefore, once being defined in one drawing, a certain item does not need to be further defined or explained in subsequent drawings. Meanwhile, in the description of the present disclosure, terms, such as “first” and “second”, are only used for distinguishing the description, but should not be understood as indicating or suggesting a relative importance.

### First Embodiment

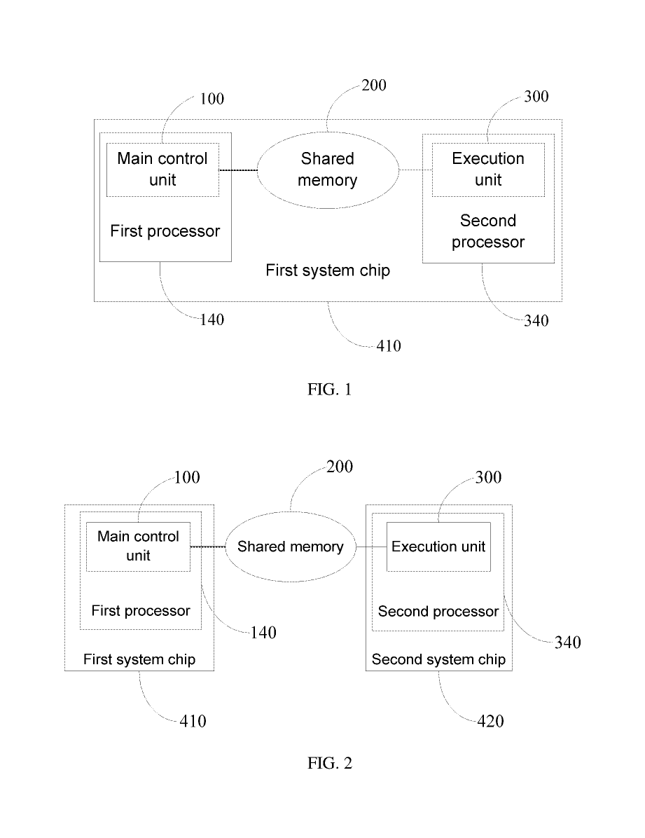

FIG. 1 shows a structural block diagram of a motor control device provided by an embodiment of the present disclosure. The motor control device provided by the embodiment of the present disclosure is configured to adjust a load into its target attitude by controlling one or more motors on the load. The motor control device provided by the embodiment of the present disclosure includes a main control unit 100, a shared memory 200 and an execution unit 300. The main control unit 100 is provided on a first processor 140, the execution unit 300 is provided on a second processor 340, and the first processor 140, the shared memory 200 and the second processor 340 may be integrated onto a first system chip 410. Data interaction between the main control unit 100 and the execution unit 300 is implemented by means of the shared memory 200.

As shown in FIG. 2, in another embodiment, the first processor 140 may be provided on the first system chip 410, and the second processor 340 may be provided on a second system chip 420. The first system chip 410 and the second system chip 420 may be independent chips. The data interaction between the main control unit 100 and the execution unit 300 is implemented by means of the shared memory 200. FIG. 2 shows a situation where the shared memory 200 is independent from both the first system chip 410 and the second system chip 420; however, the shared memory 200 may also be provided on the first system chip 410 or the second system chip 420.

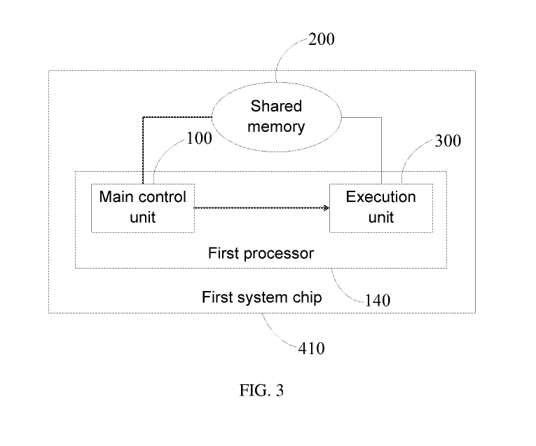

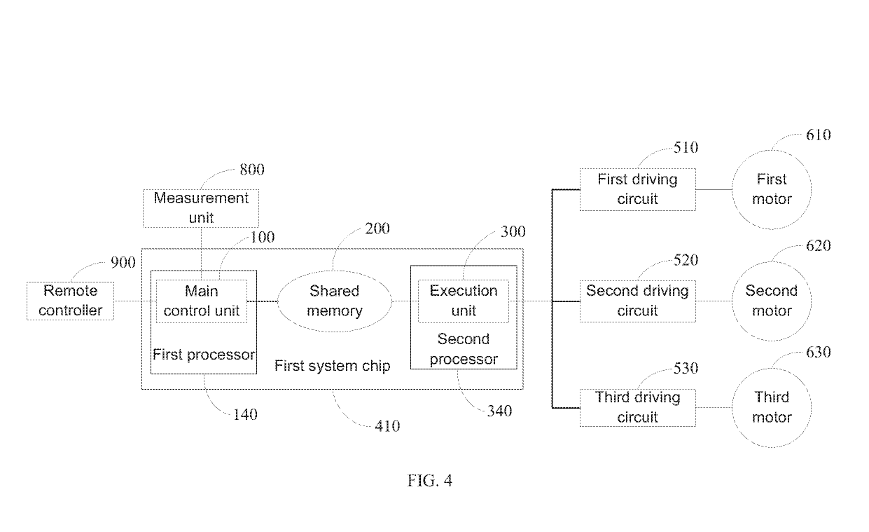

As shown in FIG. 3, in still another embodiment, the main control unit 100 and the execution unit 300 both may be provided on the first processor 140, and the first processor 140 and the shared memory 200 may be provided on the first system chip 410.

Specifically, the execution unit 300 is configured to acquire current operation parameter information of the one or more motors on the load, and store it in the shared memory 200.

Referring to FIG. 4, taking a case where the load is a gimbal as an example, it shows a structural block diagram of a motor control system in which the motor control device provided by an embodiment of the present disclosure is applied. The main control unit 100 is electrically connected with a measurement unit 800. The execution unit 300 is electrically connected with a first motor 610, a second motor 620 and a third motor 630 by means of a first driving circuit 510, a second driving circuit 520 and a third driving circuit 530, respectively. In an embodiment of the present disclosure, by controlling at least one of the motors on the three axes (the first motor 610, the second motor 620 and the third motor 630), the gimbal may reach its target attitude by means of an action of the motor, thereby achieving the stability augmentation of the gimbal or making the gimbal tilt a specific angle.

The current operation parameter information of the motor may include a power of the motor, a frequency of the motor, a voltage and a current of the motor, a current angle data of the motor and the like, where the current angle data of the motor may include an electrical angle of a rotor of the motor. In FIG. 4, the first motor 610, the second motor 620 and the third motor 630 may be provided with magnetic encoders, where each magnetic encoder may obtain an electrical angle of the rotor of the corresponding motor at any time. The execution unit 300 may acquire, from the magnetic encoder on each motor, the electrical angle of the rotor of the corresponding motor, and upload the electrical angle of the rotor of the motor to the shared memory 200. Alternatively, each of the first motor 610, the second motor 620 and the third motor 630 may also be provided with other angle measurement sensors or other sensors measuring operation parameters of the motor, other than the magnetic encoder, the specific implementations of the present disclosure are not limited thereto.

The shared memory 200 is configured to store interactive data between the main control unit 100 and the execution unit 300, where the interactive data includes the control information and the current operation parameter information of the motors. The main control unit 100 and the execution unit 300 implement the data interaction therebetween by reading data stored in the shared memory 200.

The main control unit 100 is configured to read the current operation parameter information of the motors stored in the shared memory 200, calculate the control information in accordance with current attitude information of the gimbal, target attitude information of the gimbal and the current operation parameter information of the motors, and store the calculated control information in the shared memory 200. In addition, in a case that the control information may be calculated out only by acquiring the target attitude information of the gimbal and the current operation parameter information of the motors without acquiring the current attitude information of the gimbal, the calculated control information may also be stored in the shared memory 200.

In the case that the main control unit 100 and the execution unit 300 are respectively provided on the first processor 140 and the second processor 340, the execution unit 300 may, after uploading the current operation parameter information of the one or more motors on the gimbal to the shared memory 200, transmit a first interrupt signal and transfer the first interrupt signal to the main control unit 100 by means of the shared memory 200. Alternatively, the first interrupt signal may also be directly transmitted to the main control unit 100 by the execution unit 300, the specific implementations of the present disclosure are not limited thereto. Upon receiving the first interrupt signal, the main control unit 100 interrupts a task being executed currently and calls a first processing function, and updates the current operation parameter information in calling the first processing function. In this way, the main control unit 100 may read the current operation parameter information of the one or more motors on the gimbal stored in the shared memory 200, and calculate the control information in accordance with the updated current operation parameter information in calling the first processing function.

In the case that the main control unit 100 and the execution unit 300 both are provided on the first processor 140, after the execution unit 300 uploads the current operation parameter information of the one or more motors on the gimbal to the shared memory 200, the main control unit 100 may read the current operation parameter information of the motors from the shared memory 200 directly, without performing interruption. For example, upon detecting that the execution unit 300 has uploaded the current operation parameter information of the one or more motors on the gimbal to the shared memory 200, the first processor 140 may command the main control unit 100 to read the current operation parameter information from the shared memory 200. Since the above operations are executed in the same processor rather than in different processors, it is not necessary to perform an interrupt operation.

The measurement unit 800 may be configured to measure attitude information of the gimbal, for example, it may be an attitude sensor. Specifically, the measurement unit 800 may be an Inertial Measurement Unit (IMU) including a gyroscope, an accelerometer and the like, and the IMU may be fixed onto a camera component carried by the gimbal. Accordingly, the measurement unit 800 may acquire the current attitude information of the gimbal, and transmit it to the main control unit 100.

As shown in FIG. 4, the main control unit 100 may further communicate with a remote controller 900 wirelessly, so as to receive the target attitude information of the gimbal transmitted by the remote controller 900. The target attitude information may be relevant data used for causing the gimbal to reach its target attitude. Generally, the target attitude of the gimbal may refer to a desired attitude of the gimbal with respect to the current attitude thereof, for example, a desired attitude of the gimbal with a pitching angle of 25 degrees and/or a rolling angle of 30 degrees and/or a yaw angle of 45 degrees changed with respect to the current attitude of the gimbal. The target attitude information of the gimbal transmitted by the remote controller 900 is generally set by a user in accordance with actual requirements.

Further, the control information calculated by the main control unit 100 is used to control each motor, and the control information may include the magnitude and the direction of a force used to control the motor to rotate. The control information may be calculated by the main control unit 100 with the following steps:

Step S100, reading, by the main control unit 100, acceleration information on the three axes and angular velocity information on the three axes from the measurement unit 800, i.e., the IMU fixed onto the camera component, and performing, by the main control unit 100, a Kalman filtering algorithm on the read information to obtain attitude information of a camera lens in the camera component relative to the ground (a pitching angle, a rolling angle and a yaw angle) and an acceleration and an angular velocity at which the camera lens moves, where the attitude information of the camera lens relative to the ground is the current attitude information of the gimbal;

Step S200, obtaining a direction cosine matrix that transforms from a lens coordinate system (the lens coordinate system refers to a coordinate system defined in a case that the lens is placed horizontally, with two axes in the horizontal plane passing through the center of the lens and perpendicular to each other set as the X axis and the Y axis, and with an axis perpendicular to the horizontal plane set as the Z axis, where the lens coordinate system may move accordingly with the movement of the lens) to a current gimbal coordinate system (which refers to a coordinate system constituted by current positions of the motors on the three axes of the gimbal) in accordance with electrical angles of the rotors of the motors, being the current operation parameter information of the motors, read by the magnetic encoders of the motors on the three axes, and mapping the current attitude information of the gimbal obtained in step S100 onto rotation directions of shafts of the motors on the gimbal in accordance with the direction cosine matrix, so as to obtain information components of the current attitude information of the gimbal in the rotation directions of the shafts of the motors on the gimbal;

Step S300, mapping the target attitude information (which is in the lens coordinate system) of the gimbal transmitted by the remote controller 900 into the current gimbal coordinate system (which refers to a coordinate system constituted by current positions of the motors on the three axes of the gimbal), in accordance with the direction cosine matrix obtained in step S200; and

Step S400, performing an incremental Proportion-Integral-Derivative (PID) operation on the current attitude information mapped onto the rotation directions of the shafts of the motors on the gimbal and the target attitude information mapped into the current gimbal coordinate system, so as to obtain the control information for controlling the motors. Then, the main control unit 100 transmits the control information to the shared memory 200 for storage.

The execution unit 300 is further configured to read the control information stored in the shared memory 200, and control the motors in accordance with the control information, so as to adjust the gimbal into its target attitude by mean of the controlling over the motors.

In the case that the main control unit 100 and the execution unit 300 are respectively provided on the first processor 140 and the second processor 340, the main control unit 100 may, after transmitting the control information to the shared memory 200, transmit a second interrupt signal and transfer the second interrupt signal to the execution unit 300 by means of the shared memory 200. Alternatively, the second interrupt signal may also be directly transmitted to the execution unit 300 by the main control unit 100, the specific implementations of the present disclosure are not limited thereto. Upon receiving the second interrupt signal, the execution unit 300 interrupts a task being executed currently and calls a second processing function, and updates the control information in calling the second processing function. In this way, the execution unit 300 may read the control information stored in the shared memory 200, and control the individual motors in accordance with the updated control information in calling the second processing function.

In the case that the main control unit 100 and the execution unit 300 both are provided on the first processor 140, after the main control unit 100 transmits the control information to the shared memory 200, the execution unit 300 may read the control information from the shared memory 200 directly, without performing interruption. For example, upon detecting that the main control unit 100 has transmitted the control information to the shared memory 200, the first processor 140 may command the execution unit 300 to read the control information from the shared memory 200. Since the above operations are executed in the same processor rather than in different processors, it is not necessary to perform an interrupt operation.

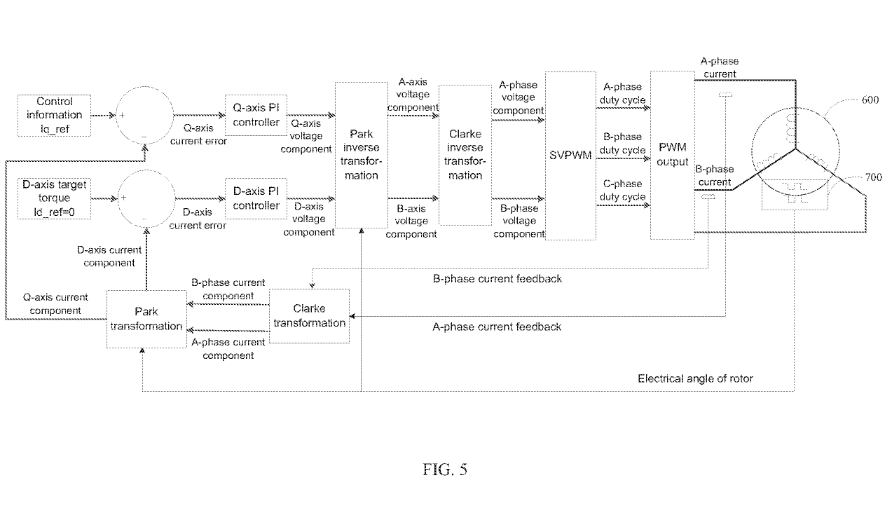

FIG. 5 shows a flowchart block diagram illustrating a motor 600 is controlled by the execution unit 300 in accordance with the control information. The motor 600 is provided with a magnetic encoder 700 which measures an electrical angle of the rotor of the motor. The process of controlling the motor 600 by the execution unit 300 in accordance with the control information may be implemented with a Field Oriented Control (FOC) algorithm and a PID algorithm, which are detailed as follows.

An A-phase current and a B-phase current of a stator are extracted by a phase current detection circuit, and then converted to be in a two phase coordinate system of the stator via Clarke transformation, so as to obtain an A-phase current component and a B-phase current component. Next, in accordance with the electrical angle of the rotor, the A-phase current component and the B-phase current component are converted to be in a D-Q rotating coordinate system with Park transformation, so as to obtain a D-axis current component and a Q-axis current component, where in the D-Q coordinate system, the Q axis is in a direction of the tangent to the rotor, and the D axis is obtained by rotating the Q axis 90 degrees clockwise. Then, the Q-axis current component and the D-axis current component in the D-Q coordinate system are compared with their corresponding reference inputs Iq_ref and Id_ref respectively, so as to obtain a Q-axis current error and a D-axis current error, where Id_ref=0, and Iq_ref is the control information (including the magnitude and the direction of the force). Then, each of the Q-axis current error and the D-axis current error is processed by a Proportional Integral (PI) controller, to obtain a Q-axis voltage component and a D-axis voltage component. Then, Park inverse transformation is performed on the Q-axis voltage component and the D-axis voltage component in accordance with the electrical angle of the rotor, to obtain voltage components in the two phase coordinate system (an A-B coordinate system) of the stator, that is, an A-axis voltage component and a B-axis voltage component. Then, Clarke inverse transformation is performed on the A-axis voltage component and the B-axis voltage component in the A-B coordinate system, to obtain an A-phase voltage component and a B-phase voltage component. And then, with a Space Vector Pulse Width Modulation (SVPWM) technique, duty cycles of pulse width modulation signals controlling three phase symmetrical windings of the stator, i.e., an A-phase duty cycle, a B-phase duty cycle and a C-phase duty cycle, are obtained. Finally, they are output to the three phase symmetrical windings of the stator of the motor by means of Pulse Width Modulation (PWM). Accordingly, the motor is controlled in accordance with the control information.

In order to prevent decrease of the control frequency and the control accuracy of the motor, in this embodiment, all floating point operations including the FOC operation are converted into fixed point operations, and the position-type PID algorithm is replaced with the incremental PID control algorithm in which the proportional coefficient Kp and the integral coefficient Ki are smaller; moreover, the multiplication operation in the PID algorithm after the replacement is totally implemented by a shifting operation of integer data, without performing a floating operation. As for the trigonometric function operations involved in the Clarke transformation and the Park transformation, numerical values of trigonometric functions involving variables from −90 degrees to 90 degrees are pre-calculated and saved in the shared memory 200, such that relevant data stored in the shared memory 200 may be read directly when there is a need to perform the trigonometric function operation.

### Second Embodiment

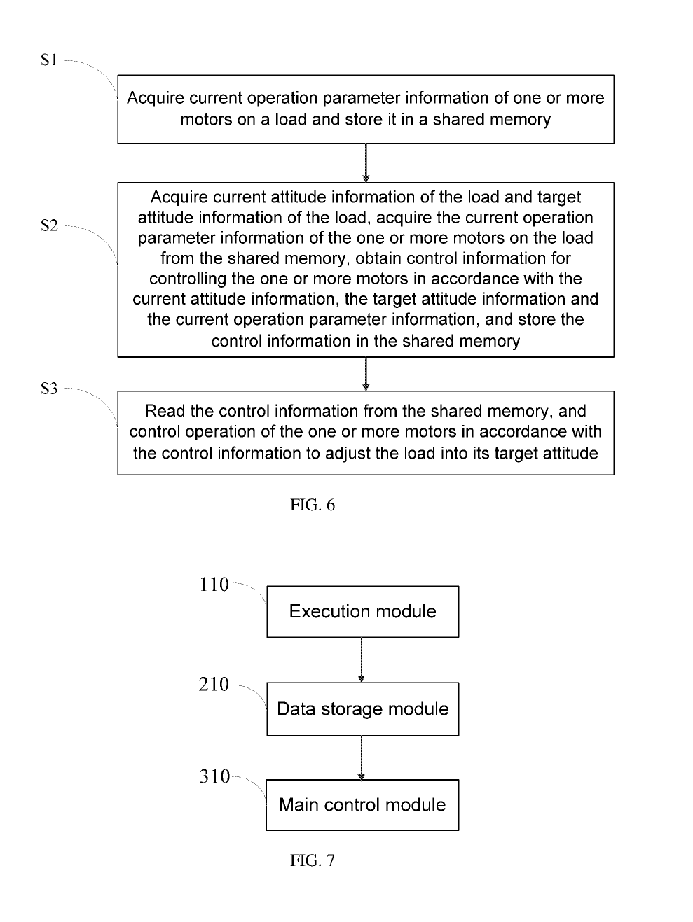

FIG. 6 shows a flowchart of a motor control method provided by an embodiment of the present disclosure. The motor control method provided by the embodiment of the present disclosure includes the following steps S1 to S3.

In step S1, current operation parameter information of one or more motors on a load is acquired, and stored in a shared memory.

In the embodiment of the present disclosure, step S1 may be implemented by an execution unit 300. The current operation parameter information of the motor may include a power of the motor, a frequency of the motor, a voltage and a current of the motor, a current angle data of the motor and the like, where the current angle data of the motor may include an electrical angle of a rotor of the motor. A first motor 610, a second motor 620 and a third motor 630 may be provided with magnetic encoders, where each magnetic encoder may obtain an electrical angle of the rotor of the corresponding motor at any time. The execution unit 300 may acquire, from the magnetic encoder on each motor, the electrical angle of the rotor of the corresponding motor, and upload the acquired electrical angle of the rotor of the motor to the shared memory 200.

In step S2, current attitude information of the load and target attitude information of the load are acquired, and the current operation parameter information of the one or more motors on the load is acquired from the shared memory 200, control information for controlling the one or more motors is obtained in accordance with the current attitude information, the target attitude information and the current operation parameter information, and the control information is stored in the shared memory 200.

In this embodiment of the present disclosure, step S2 may be implemented by a main control unit 100. In the case that the main control unit 100 and the execution unit 300 are respectively provided on a first processor 140 and a second processor 340, the execution unit 300 may, after uploading the current operation parameter information of the one or more motors on the load to the shared memory 200, transmit a first interrupt signal and transfer the first interrupt signal to the main control unit 100 by means of the shared memory 200. Alternatively, the first interrupt signal may also be directly transmitted to the main control unit 100 by the execution unit 300, the specific implementations of the present disclosure are not limited thereto. Upon receiving the first interrupt signal, the main control unit 100 interrupts a task being executed currently and calls a first processing function, and updates the current operation parameter information in calling the first processing function. In this way, the main control unit 100 may read the current operation parameter information of the one or more motors on the gimbal from the shared memory 200, and calculate the control information in accordance with the updated current operation parameter information in calling the first processing function.

In the case that the main control unit 100 and the execution unit 300 both are provided on the first processor 140, after the execution unit 300 uploads the current operation parameter information of the one or more motors on the load to the shared memory 200, the main control unit 100 may read the current operation parameter information of the motors from the shared memory 200 directly, without performing interruption. For example, upon detecting that the execution unit 300 has uploaded the current operation parameter information of the one or more motors on the gimbal to the shared memory 200, the first processor 140 may command the main control unit 100 to read the current operation parameter information from the shared memory 200. Since the above operations are executed in the same processor rather than in different processors, it is not necessary to perform an interrupt operation.

Taking a case where the load is a gimbal as an example, the current attitude information of the gimbal may be measured by a measurement unit 800. Specifically, the measurement unit 800 may be an IMU including a gyroscope, an accelerometer and the like, and the IMU may be fixed onto a camera component carried by the gimbal. Accordingly, the measurement unit 800 may acquire the current attitude information of the gimbal, and transmit it to the main control unit 100.

The main control unit 100 may further communicate with a remote controller 900 wirelessly, so as to receive target attitude information of the gimbal transmitted by the remote controller 900. The target attitude information may be relevant data used for causing the gimbal to reach its target attitude. Generally, the target attitude of the gimbal may refer to a desired attitude of the gimbal with respect to the current attitude thereof, for example, a desired attitude of the gimbal with a pitching angle of 25 degrees and/or a rolling angle of 30 degrees and/or a yaw angle of 45 degrees changed with respect to the current attitude of the gimbal. The target attitude information of the gimbal transmitted by the remote controller 900 is generally set by a user in accordance with actual requirements.

Further, the control information calculated by the main control unit 100 is used to control each motor, and the control information may include the magnitude and the direction of a force used to control the motor to rotate. The control information may be calculated by the main control unit 100 with the following steps:

Step S100, reading, by the main control unit 100, acceleration information on the three axes and angular velocity information on the three axes from the measurement unit 800, i.e., the IMU fixed onto the camera component, and performing, by the main control unit 100, a Kalman filtering algorithm on the read information to obtain attitude information of a camera lens in the camera component relative to the ground (a pitching angle, a rolling angle and a yaw angle) and an acceleration and an angular velocity at which the camera lens moves, where the attitude information of the camera lens relative to the ground is the current attitude information of the gimbal;

Step S200, obtaining a direction cosine matrix that transforms from a lens coordinate system (the lens coordinate system refers to a coordinate system defined in a case that the lens is placed horizontally, with two axes in the horizontal plane passing through the center of the lens and perpendicular to each other set as the X axis and the Y axis, and with an axis perpendicular to the horizontal plane set as the Z axis, where the lens coordinate system may move accordingly with the movement of the lens) to a current gimbal coordinate system (which refers to a coordinate system constituted by current positions of the motors on the three axes of the gimbal) in accordance with electrical angles of the rotors of the motors read by the magnetic encoders of the motors on the three axes, and mapping the current attitude information of the gimbal obtained in step S100 onto rotation directions of shafts of the motors on the gimbal in accordance with the direction cosine matrix, so as to obtain information components of the current attitude information of the gimbal in the rotation directions of the shafts of the motors on the gimbal;

Step S300, mapping the target attitude information (which is in the lens coordinate system) of the gimbal transmitted by the remote controller 900 into the current gimbal coordinate system (which refers to a coordinate system constituted by current positions of the motors on the three axes of the gimbal), in accordance with the direction cosine matrix obtained in step S200; and

Step S400, performing an incremental PID operation on the current attitude information mapped onto the rotation directions of the shafts of the motors on the gimbal and the target attitude information mapped into the current gimbal coordinate system, so as to obtain the control information for controlling the motors. Then, the main control unit 100 transmits the control information to the shared memory 200 for storage.

The execution unit 300 is further configured to read the control information stored in the shared memory 200, and control the motors in accordance with the control information, so as to adjust the gimbal into its target attitude by mean of the controlling over the motors.

It should be noted that, the above steps S100 to S400 just give a preferable implementation for calculating the control information, and the control information may be obtained with other algorithms, where the present disclosure does not limit the method for calculating the control information.

In step S3, the control information is read from the shared memory 200, and operation of the one or more motors is controlled in accordance with the control information, so as to adjust the load into its target attitude.

In this embodiment of the present disclosure, step S3 may be implemented by the execution unit 300. In the case that the main control unit 100 and the execution unit 300 are respectively provided on the first processor 140 and the second processor 340, the main control unit 100 may, after transmitting the control information to the shared memory 200, transmit a second interrupt signal and transfer the second interrupt signal to the execution unit 300 by means of the shared memory 200. Alternatively, the second interrupt signal may also be directly transmitted to the execution unit 300 by the main control unit 100, the specific implementations of the present disclosure are not limited thereto. Upon receiving the second interrupt signal, the execution unit 300 interrupts a task being executed currently and calls a second processing function, and updates the control information in calling the second processing function. In this way, the execution unit 300 may read the control information stored in the shared memory 200, and control the individual motors in accordance with the updated control information in calling the second processing function.

In the case that the main control unit 100 and the execution unit 300 both are provided on the first processor 140, after the main control unit 100 transmits the control information to the shared memory 200, the execution unit 300 may read the control information from the shared memory 200 directly, without performing interruption. For example, upon detecting that the main control unit 100 has transmitted the control information to the shared memory 200, the first processor 140 may command the execution unit 300 to read the control information from the shared memory 200. Since the above operations are executed in the same processor rather than in different processors, it is not necessary to perform an interrupt operation.

The process of controlling the motor 600 by the execution unit 300 in accordance with the control information may be implemented with a FOC algorithm and a PID algorithm, which are detailed as follows (referring to FIG. 5):

An A-phase current and a B-phase current of a stator are extracted by a phase current detection circuit, and then converted to be in a two phase coordinate system of the stator via Clarke transformation, so as to obtain an A-phase current component and a B-phase current component. Next, in accordance with the electrical angle of the rotor, the A-phase current component and the B-phase current component are converted to be in a D-Q rotating coordinate system with Park transformation, so as to obtain a D-axis current component and a Q-axis current component, where in the D-Q coordinate system, the Q axis is in a direction of the tangent to the rotor, and the D axis is obtained by rotating the Q axis 90 degrees clockwise. Then, the Q-axis current component and the D-axis current component in the D-Q coordinate system are compared with their corresponding reference inputs Iq_ref and Id_ref respectively, so as to obtain a Q-axis current error and a D-axis current error, where Id_ref=0, and Iq_ref is the control information (including the magnitude and the direction of the force). Then, each of the Q-axis current error and the D-axis current error is processed by a Proportional Integral (PI) controller, to obtain a Q-axis voltage component and a D-axis voltage component. Then, Park inverse transformation is performed on the Q-axis voltage component and the D-axis voltage component in accordance with the electrical angle of the rotor, to obtain voltage components in the two phase coordinate system (an A-B coordinate system) of the stator, that is, an A-axis voltage component and a B-axis voltage component. Then, Clarke inverse transformation is performed on the A-axis voltage component and the B-axis voltage component in the A-B coordinate system, to obtain an A-phase voltage component and a B-phase voltage component. And then, with a Space Vector Pulse Width Modulation (SVPWM) technique, duty cycles of pulse width modulation signals controlling three phase symmetrical windings of the stator, i.e., an A-phase duty cycle, a B-phase duty cycle and a C-phase duty cycle, are obtained. Finally, they are output to the three phase symmetrical windings of the stator of the motor by means of Pulse Width Modulation (PWM). Accordingly, the motor is controlled in accordance with the control information.

In order to prevent decrease of the control frequency and the control accuracy of the motor, in this embodiment, all floating point operations including the FOC operation are converted into fixed point operations, and the position-type PID algorithm is replaced with the incremental PID control algorithm in which the proportional coefficient Kp and the integral coefficient Ki are smaller; moreover, the multiplication operation in the PID algorithm after the replacement is totally implemented by a shifting operation of integer values, without performing a floating operation. As for the trigonometric function operations involved in the Clarke transformation and the Park transformation, numerical values of trigonometric functions involving variables from −90 degrees to 90 degrees are pre-calculated and saved in the shared memory 200, such that relevant data stored in the shared memory 200 may be read directly by a look-up table when there is a need to perform the trigonometric function operation.

It should be noted that, the above process is just a process in which the execution unit 300 controls one motor 600 in accordance with the control information of the motor 600. It should be appreciated that, in accordance with the control information corresponding to the motors on the three axes (the first motor 610, the second motor 620 and the third motor 630) in FIG. 4, the execution unit 300 may also control respective motors separately or simultaneously, thereby implementing the stability augmentation of the gimbal or adjusting the gimbal into its target attitude.

It should be noted that, the motor control device and method provided by the embodiments of the present disclosure may also be applied to a flight control system (flight control) of a UAV carrying a camera, a video camera, a sensing device (such as a temperature probe, an infrared probe or a multispectral scanner), a loudspeaker, a pesticide case and the like, or applied to other multi-motor control systems, which is not limited to above embodiments of the present disclosure illustrating applications for the gimbal. It should be appreciated that, the gimbal, the camera, the video camera, the sensing device (such as the temperature probe, the infrared probe, or the multispectral scanner), the loudspeaker, the pesticide case described above or any combination thereof may be collectively called as a load. Correspondingly, the motor control device and method provided by the embodiments of the present disclosure may be used to control the operation of motors on the above load, so as to adjust the load into its target attitude.

A UAV is also provided by another embodiment of the present disclosure, which may include a memory, one or more processors, one or more modules and a load having one or more motors. The one or more modules are stored in the memory and executed by the one or more processors. The one or more modules include (referring to FIG. 7): an execution module 110, a main control module 310 and a data storage module 210.

The main control module 310 is configured to acquire current attitude information of the load, target attitude information of the load and current operation parameter information of the one or more motors on the load, obtain control information for controlling the one or more motors in accordance with the current attitude information, the target attitude information and the current operation parameter information, and transmit the control information to the data storage module 210 for storage. The execution module 110 is configured to read the control information from the data storage module 210, and control operation of the one or more motors in accordance with the control information.

The execution module 110, the main control module 310 and the data storage module 210 cooperate with each other, to control the motors on the three axes for maintaining the stability of the gimbal on the UAV, or to control motors of other loads on the UAV. As for specific functions of the execution module 110, the main control module 310 and the data storage module 210, reference may be made to corresponding description of the above motor control method, which will not be repeated herein. The one or more processors may be for example at least one of the first processor 140 and the second processor 340. In addition, the term “module” includes a combination of software and/or hardware which may implement a predetermined function. Although the module described in this embodiment is preferably implemented by software, it is possible and conceivable to implement the module by hardware or a combination of software and hardware.

A computer readable medium is further provided by an embodiment of the present disclosure, which has non-volatile program codes executable by a processor, the program codes, when executed by the processor, execute the following method to control one or more motors on a load:

S10, acquiring current attitude information of the load and target attitude information of the load and current operation parameter information of the one or more motors on the load is acquired, and obtaining control information for controlling the one or more motors in accordance with the current attitude information, the target attitude information and the current operation parameter information;

S20, transmitting the control information to a shared memory for storage; and

S30, reading the control information from the shared memory, and controlling operation of the one or more motors in accordance with the control information.

In addition, the computer readable medium may also be set to store other program codes for executing the motor control method. The processor may be selected from the processors as described above.

Optionally, in this embodiment, the above computer readable medium may include but not limited to a universal disk, a Read-Only Memory (ROM), a Random Access Memory (RAM), a movable hard disk, a magnetic disk, an optical disk or other media capable of storing program codes.

With the UAV, the motor control device and method provided by the embodiments of the present disclosure, the current attitude information of the load, the target attitude information of the load and the current operation parameter information of the one or more motors on the load are acquired, and control information for controlling the one or more motors is obtained in accordance with the current attitude information, the target attitude information and the current operation parameter information; the control information is transmitted to the shared memory for storage; and the control information is read from the shared memory, and the operation of the one or more motors is controlled in accordance with the control information. In the UAV, the motor control device and method provided by the embodiments of the present disclosure, since the shared storage unit is used as a data interactive medium, the control circuit for the motors no longer needs any cable or PCB wiring to connect the main control unit and the execution unit, thereby reducing the size of hardware. Moreover, such a data interactive medium enables information transmission to be implemented directly inside a chip, thereby improving the reliability of communication, preventing a hidden trouble that one or some motors do not respond due to disconnection of a communication line, and further improving the speed and stability of data interaction between the main control unit and the execution unit. Meanwhile, the operation including the FOC algorithm is implemented by the fixed point operation and a shifting operation of integer data, and the trigonometric function operation is implemented by means of a lookup table, thereby preventing decrease of the control frequency and the control accuracy of motor, and thus preventing decrease of the control frequency and the control accuracy of the load.

It should be noted that, relational terms such as “first” and “second” in this text are only used to distinguish one entity or operation from another entity or operation, without necessarily requiring or suggesting any of such an actual relationship or order exists between these entities or operations. Moreover, terms such as “comprise”, “comprising” or any other variations thereof are intended to cover non-exclusive inclusion, so that a process, a method, an article or an apparatus including a series of elements includes not only such elements but also other elements not specified clearly, or further includes elements inherent in the process, the method, the article or the apparatus. Without specific limitations, an element defined by an expression “comprising a . . . ” does not exclude a case where another same element exists in the process, the method, the article or the apparatus including the element.

The foregoing description only gives preferable embodiments of the present disclosure, and does not used to limit the present disclosure. For those skilled in the art, various modifications and variations may be made to the present disclosure. Any amendments, equivalent replacements, improvements and the like, made within the spirit and principle of the present disclosure, should be covered by the scope of protection of the present disclosure. It should be noted that, similar reference signs and letters represent similar items in the following drawings. Therefore, once being defined in one drawing, a certain item does not need to be further defined or explained in subsequent drawings.

1. A motor control device, configured to control one or more motors on a load, comprising:
an execution unit, a main control unit and a shared memory,
the main control unit configured to acquire current attitude information of the load, target attitude information of the load and current operation parameter information of the one or more motors on the load, obtain control information for controlling the one or more motors in accordance with the current attitude information, the target attitude information and the current operation parameter information, and transmit the control information to the shared memory for storage; and the execution unit is configured to read the control information from the shared memory, and control operation of the one or more motors in accordance with the control information.

2. The motor control device according to claim 1, wherein the execution unit is further configured to upload the current operation parameter information of the one or more motors on the load to the shared memory, and the main control unit is further configured to acquire the current operation parameter information of the one or more motors on the load from the shared memory.

3. The motor control device according to claim 1, wherein the main control unit and the execution unit both are provided on a first processor.

4. The motor control device according to claim 1, wherein the main control unit is provided on a first processor, the execution unit is provided on a second processor, and the first processor, the second processor and the shared memory are provided on a first system chip.

5. The motor control device according to claim 1, wherein the main control unit is provided on a first processor, the execution unit is provided on a second processor, the first processor is provided on a first system chip, and the second processor is provided on a second system chip.

6. The motor control device according to claim 5, wherein the execution unit is further configured to transmit, after uploading the current operation parameter information of the one or more motors on the load to the shared memory, a first interrupt signal to trigger the main control unit to acquire the current operation parameter information of the one or more motors on the load from the shared memory.

7. The motor control device according to claim 5, wherein the main control unit is further configured to transmit, after transmitting the control information to the shared memory for storage, a second interrupt signal to trigger the execution unit to read the control information from the shared memory.

8. The motor control device according to claim 1, wherein the current operation parameter information of the one or more motors comprises current angle data of the one or more motors.

9. The motor control device according to claim 1, wherein the control information is calculated by the main control unit with an incremental Proportional-Integral-Derivative algorithm, in accordance with the current attitude information, the target attitude information and the current operation parameter information.

10. The motor control device according to claim 1, wherein the execution unit controls the operation of the one or more motors in accordance with a result obtained by performing a fixed-point Field Oriented Control algorithm and an incremental Proportional-Integral-Derivative algorithm on the control information.

11. A motor control method for controlling one or more motors on a load, comprising:
acquiring current attitude information of the load, target attitude information of the load and current operation parameter information of the one or more motors on the load, and obtaining control information for controlling the one or more motors in accordance with the current attitude information, the target attitude information and the current operation parameter information;
transmitting the control information to a shared memory for storage; and
reading the control information from the shared memory, and controlling operation of the one or more motors in accordance with the control information.

12. The motor control method according to claim 11, wherein the acquiring current operation parameter information of the one or more motors on the load comprises: acquiring current operation parameter information of the one or more motors on the load from the shared memory,
wherein, before acquiring the current operation parameter information of the one or more motors on the load, the method further comprises: uploading the current operation parameter information of the one or more motors to the shared memory.

13. The motor control method according to claim 11, wherein the current operation parameter information of the one or more motors comprises current angle data of the one or more motors.

14. The motor control method according to claim 11, wherein the obtaining control information for controlling the one or more motors in accordance with the current attitude information, the target attitude information and the current operation parameter information comprises: calculating control information with an incremental Proportional-Integral-Derivative algorithm, in accordance with the current attitude information, the target attitude information and the current operation parameter information.

15. The motor control method according to claim 11, wherein the motor control method further comprises: performing calculation with a fixed-point Field Oriented Control algorithm and an incremental Proportional-Integral-Derivative algorithm on the control information before controlling the operation of the one or more motors.

16. The motor control method according to claim 15, wherein the motor control method further comprises: acquiring, before performing the fixed-point Field Oriented Control algorithm, numerical values of trigonometric functions involved in the fixed-point Field Oriented Control algorithm, and saving the numerical values in the shared memory for being called when the fixed-point Field Oriented Control algorithm is performed.

17. The motor control method according to claim 12, wherein the motor control method further comprises: transmitting, after uploading the current operation parameter information of the one or more motors on the load to the shared memory, a first interrupt signal to trigger the step of acquiring the current operation parameter information of the one or more motors on the load from the shared memory.

18. The motor control method according to claim 11, wherein the motor control method further comprises: transmitting, after transmitting the control information to the shared memory for storage, a second interrupt signal to trigger the step of reading the control information from the shared memory.

19. An unmanned aerial vehicle, comprising:
a load having one or more motors,
a memory,
one or more processors; and
one or more modules configured to be stored in the memory and executed by the one or more processors, wherein the one or more modules comprises an execution module, a main control module and a data storage module,
the main control module is configured to acquire current attitude information of the load, target attitude information of the load and current operation parameter information of the one or more motors on the load, obtain control information for controlling the one or more motors in accordance with the current attitude information, the target attitude information and the current operation parameter information, and transmit the control information to the data storage module for storage; and the execution module is configured to read the control information from the data storage module, and control operation of the one or more motors in accordance with the control information.
